(19) United States
(12) Patent Application Publication
(10) Pub. No.: US 2021/0041108 A1
(43) Pub. Date: Feb. 11, 2021

(54) APPARATUSES FOR RADIANT HEATING

(71) Applicant: Eidon, LLC, Mercer Island, WA (US)

(72) Inventor: Roger N. Johnson, Mercer Island, WA (US)

(73) Assignee: Eidon, LLC, Mercer Island, WA (US)

(21) Appl. No.: 16/988,542

(22) Filed: Aug. 7, 2020

Related U.S. Application Data
(60) Provisional application No. 62/884,868, filed on Aug. 9, 2019.

(51) Int. Cl. F24C 7/04; H05B 3/00

(52) U.S. Cl. CPC F24C 7/043; F26B 3/28; H05B 3/008

(57) ABSTRACT

Embodiments of the disclosure are drawn to apparatuses for electric radiant heaters. An electric radiant heater may include a cavity with a radiant heating element on an inner surface of the cavity. Electric radiant heat generated by the radiant heating element may be output through an aperture of the cavity. The inner surface of the cavity may have a greater surface area than an area of the aperture. The radiant heating element may be arranged in a helical pattern in some examples. In some examples, the electric radiant heater may be arranged with a lens for directing heat from the radiant heating element to a location outside the cavity.

### CROSS-REFERENCE TO RELATED APPLICATION(S)

This application claims the benefit under 35 U.S.C. § 119 of the earlier filing date of U.S. Provisional Application Ser. No. 62/884,868, filed Aug. 9, 2019, the entire contents of which is hereby incorporated by reference in its entirety for any purpose.

### BACKGROUND

Radiant heaters convert gas, electric, or other non-radiant energy into radiant energy (e.g., energy transmitted by electromagnetic radiation). The radiant energy, e.g., radiant heat, is typically used to warm another object or space. For example, a radiant heater may be used to warm a room and/or keep prepared food warm.

An electric radiant heater typically includes an element that generates radiant heat responsive to a current passing through the element. The output of the electric radiant heater may be limited due to several factors such as spacing and/or current limitations of the element. The efficiency of the electric radiant heater may be also be limited due to several factors such as convective gas flow across the element (e.g., movement of heated ambient air). Accordingly, electrical radiant heaters with higher output and efficiency are desired.

### SUMMARY

As described herein, an apparatus according to principles of the present disclosure may include a cavity having a concave inner surface, wherein an area of the inner surface is greater than an aperture of the cavity and a coil at least partially embedded within a portion of the inner surface in a helical pattern, wherein the coil is partially embedded within the portion of the inner surface to provide electric radiant heating.

As described herein, an electric radiant heater assembly according to principles of the present disclosure may include a cavity having a concave inner surface, wherein an area of the inner surface is greater than an aperture of the cavity, a radiant heating element at least partially embedded within a portion of the inner surface, wherein the radiant heating element is partially embedded in a helical pattern on the inner surface to provide radiant electric heating, and a lens, wherein a diameter of the lens is equal to or greater than a diameter of the aperture, wherein the lens directs the electric radiant heat provided by the radiant heating element to a location outside the cavity.

### BRIEF DESCRIPTION OF THE DRAWINGS

FIG. 1A is a view of an electric radiant heater according to embodiments of the present disclosure.

FIG. 1B is a cross-sectional view of the electric radiant heater shown in FIG. 1A according to embodiments of the present disclosure.

FIG. 2 is an illustration of an electric radiant heater according to embodiments of the present disclosure.

FIGS. 3A-C are cross-section illustrations of a portion of an electric radiant heater according to embodiments of the present disclosure.

FIG. 3D is a magnified view of a portion of the cross-sectional illustration of FIG. 3A, according to embodiments of the disclosure.

FIG. 4 shows a cross section of an electric radiant heater assembly according to embodiments of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

A radiant heater with a concave inner surface is described herein (e.g., radiant cavity heater). A radiant heating element may be included within the cavity (e.g., on the inner surface). Heat generated by the radiant heating element may be output through an aperture (e.g., opening) of the cavity. The inner surface of the cavity may have a larger surface area than a flat radiant heater that has the same diameter as the aperture of the cavity. This may allow a larger radiant heating element (e.g., longer coil of wire) to be placed within the cavity in some applications. In some examples, the larger radiant heating element may allow the radiant heater to output more heat at the aperture than a flat radiant heater without increasing the diameter of the radiant heater. The larger surface area may allow portions of the radiant heating element to be spaced further apart (e.g., adjacent turns of the coil) while maintaining the same heat output as a flat radiant heater. In some applications, this may improve the reliability of the radiant heater as increasing the distance between portions of the radiant heating element may reduce the probability of a short or other interference between the portions of the radiant heating element.

Although the surface area is greater for the radiant heater, the inner surface of the cavity is only exposed to open air via the aperture. Thus, compared to a flat radiant heater, a ratio of area of exposure to area of surface area may be reduced in some examples. This may lead to reduced heat loss in some examples. Furthermore, the angle or curvature of the inner surface may reduce free airflow across the radiant heating element. Accordingly, in some examples, convective gas flows across the radiant heating element may be reduced. This may improve the efficiency of the radiant cavity heater in some examples.

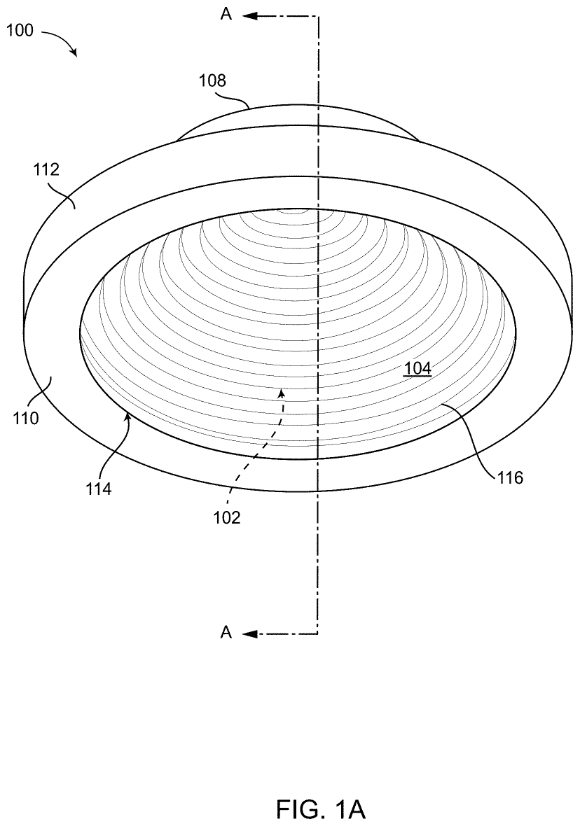

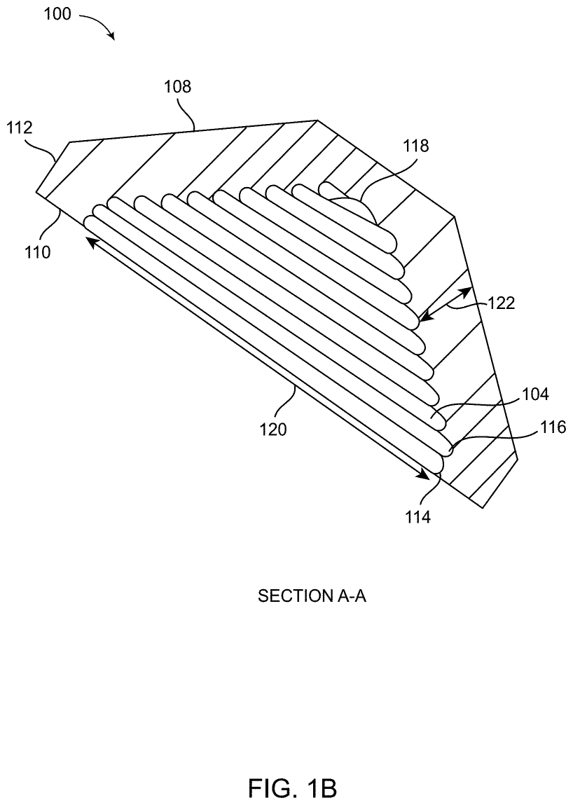

FIGS. 1A-B are drawings of an electric radiant heater 100, according to illustrated embodiments of the present disclosure. FIG. 1A is a 3D view of the electric radiant heater 100 where at least a portion of the cavity 102 is visible. FIG. 1B is a cross-sectional view of the electric radiant heater 100 taken along line A indicated in FIG. 1A. The electric radiant heater 100 may provide electric radiant heating.

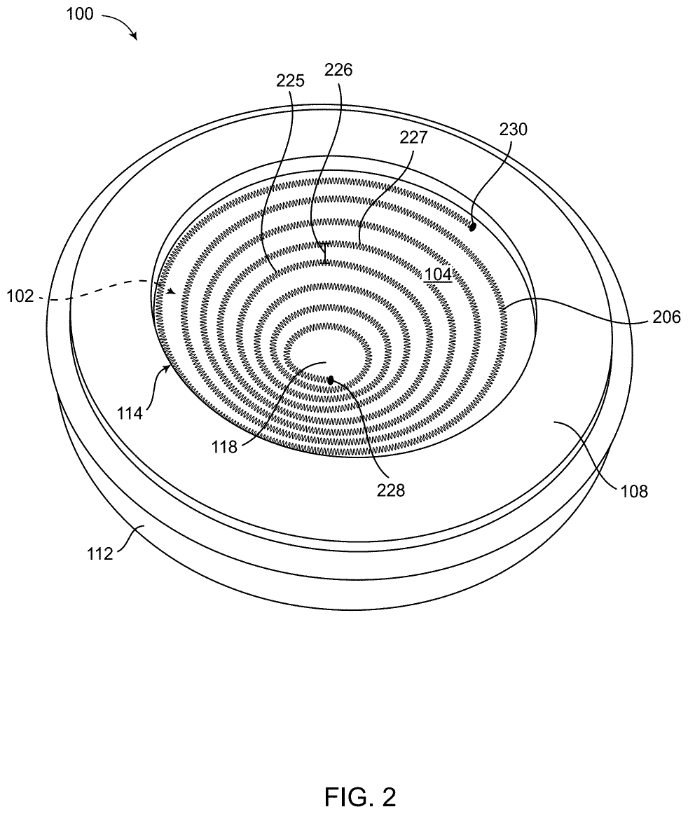

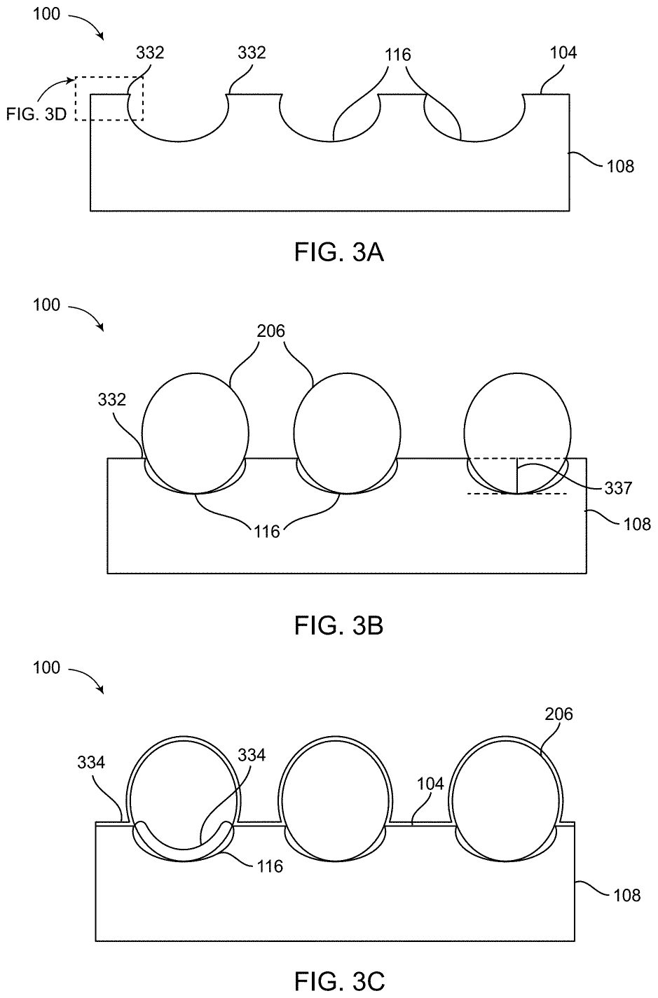

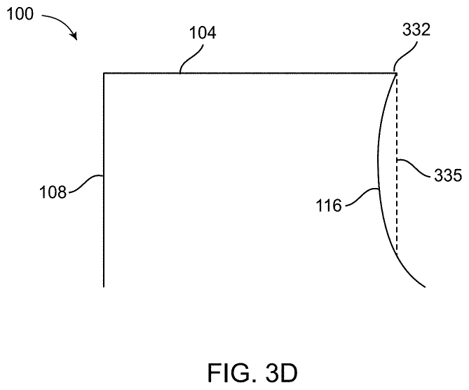

The electric radiant heater 100 may include the cavity 102 having a concave inner surface 104 and an aperture 114 with a diameter 120. The inner surface 104 of the cavity 102 may have an area greater than an area of the aperture 114 of the cavity 102. A radiant heating element 206 (shown in FIGS. 2-3) may be included on or partially embedded in a portion of the inner surface 104. The radiant heating element 206 will be described in more detail with reference to FIGS. 2-3.

In some examples, the inner surface 104 may include a groove 116. In some examples, the groove may be in a helical pattern or other pattern. At least a portion of the radiant heating element 206 may be accepted within the groove 116 as will be described in more detail with reference to FIGS. 3B-C.

The inner surface 104 may be conical (e.g., angled) and/or curved (e.g., spherical, parabolic, hyperbolic) such that any point on the inner surface 104 is in optical view of all other points on the inner surface 104. This may result in a portion of the radiant heating element 206 not embedded in a portion of the inner surface 104 being in optical view of other portions of the radiant heating element 106 not embedded in the inner surface 104. This may allow other portions of the inner surface 104 and/or portion of the radiant heating element 206 to receive heat emanating from all other portions of the radiant heating element 206 and/or the inner surface 104 (e.g., re-transmitting heat received from the radiant heating element 206). In some examples, this may allow for a more even distribution of heat across the inner surface 104 and/or radiant heating element 206, which may reduce hot spots. The reduction of hot spots may reduce failures of the radiant heating element 206 in some applications.

The cavity 102 may be formed in a thermally insulative material 108. In some examples, the thermally insulative material 108 may include aluminum oxide fibers. The thermally insulative material 108 may be molded into a bowl-like shape in some examples, such as the one shown in the example in FIGS. 1A-B. In other examples, the thermally insulative material 108 may be molded into other shapes (e.g., brick, cube, cylinder) with the cavity 102 formed therein. The thermally insulative material 108 may have an outer surface that may define an outer surface 112 of the electric radiant heater 100 in some examples. The outer surface 112 may be opposite the inner surface 104. The thermally insulative material 108 may have a thickness 122. The thickness 122 may be based, at least in part, on an amount of heat expected to be generated by the radiant heating element 206 and/or the materials included in the thermally insulative material 108. In some examples, such as the one shown in FIGS. 1A-B, the thermally insulative material 108 may define an annular rim 110. In some examples, the rim 110 may surround the aperture 114 of the cavity 102.

In some examples, the electric radiant heater 100 may provide more radiant heat at the aperture 114 than a flat radiant heater having a diameter equal to the diameter 120 of the aperture 114. For example, in some applications, the electric radiant heater 100 may provide 150 watts per square inch at the aperture compared to 120 watts per square inch at the surface of a flat radiant heater. Without being bound to a particular theory, this may be a result of the ability to include a larger heating element due to the larger surface area of the cavity 102 and/or reduced convective gas flows over the heating element 206 due to the concave cavity 102 inhibiting airflow across the heating element 206.

FIG. 2 is a 3D alternative view of the electric radiant heater 100 according to an illustrated embodiment of the present disclosure. As discussed above, the electric radiant heater 100 may include a cavity 102 formed in a thermally insulative material 108. The cavity 102 may include the concave inner surface 104, the aperture 114, and the base 118 opposite the aperture 114. The radiant heating element 206 may be partially embedded in a portion of the inner surface 104.

In some examples, 20% or less of the radiant heating element 206 may be embedded in the portion of the inner surface 104. In some applications, embedding 20% or less of the radiant heating element 206 diameter may permit more heat generated by the radiant heating element 206 to be radiated from the radiant heating element 206 into the cavity 102 and out of the aperture 114 compared to when more of the radiant heating element 206 is embedded in the inner surface 104.

The radiant heating element 206 may be electrically conductive in some examples and radiate heat responsive to an electric voltage and/or current applied to the radiant heating element 206. That is, the radiant heating element 206 may be an electric radiant heating element. The radiant heating element 206 may include one or more metallic materials (e.g., copper, nickel, chrome, iron, aluminum, tungsten) in some examples. In some examples, the radiant heating element 206 may include one or more non-metallic materials (e.g., silicon carbide). In some examples, the heating element 206 may include both metallic and non-metallic materials. The radiant heating element 206 may include one or more wires, wire coils, tubes, cables, and/or films. In some examples, the radiant heating element 206 may be a 1500 watt electric coil element.

The radiant heating element 206 may be arranged in a helical pattern (e.g., spiral) in some examples. A pitch 226 of the helical pattern may be such that a first portion of the radiant heating element 206 in one rotation 225 of the helical pattern is spaced apart from a second portion of the radiant heating element 206 in a next rotation 227 of the helical pattern. The helical pattern may extend from the base 118 to the aperture 114 in some examples. In other examples, the helical pattern may end some distance from the aperture 114. In other words, a first rotation 225 of the helical pattern may be closer to the base 118 than a second rotation 227 of the helical pattern, which may be closer to the aperture 114. The pitch 226 of the helical pattern and/or the spacing between portions or rotations 225, 227 of the radiant heating element 206 may be based, at least in part, on an electric current and/or voltage to be passed through the radiant heating element 206, a material of the radiant heating element, and/or an intended operating temperature of the radiant heating element 206. In other examples, the radiant heating element 206 may include a set of concentric rings. Other patterns may be used in other examples (e.g., zig-zag, crescent). In some examples, the radiant heating element 206 may include multiple heating elements. The pattern of the radiant heating element 206 may be the same as or substantially similar to a pattern of the groove 116 (not shown in FIG. 2).

In some examples, such as the one shown in FIG. 2, the radiant heating element 206 may pass through the inner surface 104 to the outer surface 112 through the thermally resistive material 108 of the radiant heater 100. For example, the radiant heating element 206 may pass through a hole 228 in the base 118 and/or a hole 230 near the aperture 114. Passing through the thermally resistive material 208 may allow the radiant heating element 206 to be coupled to electrical connections (e.g., voltage source, ground) outside the electric radiant heater 100. In other examples, wires or other electrical elements may pass through the thermally resistive material 108 to provide electrical coupling for the radiant heating element 206. In still other examples, the radiant heating element 206 and/or other electrical elements may pass through the aperture 114 to make electrical connections.

FIGS. 3A-C are cross-section illustrations of a portion of the electric radiant heater 100 according to illustrated embodiments of the present disclosure. FIG. 3D is a magnified view of a portion of the cross-sectional illustration of FIG. 3A, according to one illustrated embodiment.

In FIGS. 3A-C, a portion of the thermally resistive material 108 at least partially defining the inner surface 104 of the portion of the electric radiant heater is shown. The inner surface 104 may include one or more grooves 116 as discussed previously. In some examples, the grooves 116 maintain a defined distance from one another (e.g., concentric circles). In other examples, the groove 116 seen in FIGS. 3A-C may be different rotations of a helical pattern of the groove 116. The pattern in which the groove 116 is arranged may be based, at least in part, on a desired placement of the radiant heating element 206. In some examples, such as the one shown in FIGS. 3A-D, the groove 316 may include one or more overhangs 332. That is, a portion of the inner surface 104 on either side of the groove 116 may extend over a portion of the depression formed by the groove 116. As mentioned above, FIG. 3D illustrates a magnified view of the overhang 332. The extension of the overhang 332 over the portion of the depression formed by the groove 116 is indicated by dashed line 335. Although the groove 116 is shown as having a curved shape, in other examples, the groove 116 may have different shapes (e.g., rectangular, trapezoidal). The one or more overhangs 332 may be shaped to affix the radiant heating element 206 to the inner surface 104. In some embodiments, as explained below, the overhangs 332 are sized to cause the radiant heating element 206 to be affixed within the grooves 116 via mechanical pressure.

In FIGS. 3B-C, a portion of one or more radiant heating elements 206 is shown. In some examples, each groove 116 may include a separate radiant heating element 206. In other examples, such as those where there is a single groove 116 in a helical pattern, there may be a single radiant heating element 206 arranged in a helical pattern that is at least partially aligned with the helical pattern of the groove 116. As shown in FIGS. 3B-C, the groove 116 may accept at least a portion of the radiant heating element 206. In some examples, the portion accepted by the groove 116 may be 20% or less of the radiant heating element 206 as indicated by line 337. In some examples, the groove 116 may aid in placement of the heating element 206 during fabrication and/or retaining the heating element 206 within the cavity 102 during and/or after fabrication. In some examples, the one or more overhangs 332 may at least partially retain the radiant heating element 206 in the groove 116. Additionally or alternatively, the groove 116 may be sized such that the radiant heating element 206 is retained, at least in part, by friction (e.g., compression fit) between the radiant heating element 206 and the groove 116. Although shown as round in FIGS. 3B-C (e.g., tube, round wire, coil), the radiant heating element 206 may have other shapes (e.g., ovular, flat, rectangular). In some examples, the shapes of the groove 116 and radiant heating element 206 may be at least partially complementary.

In some examples, such as the one shown in FIG. 3C, a glaze 334 may at least partially encapsulate (e.g., coat) the radiant heating element 206 and/or inner surface 104. In some examples, the glaze 334 may at least partially encapsulate the groove 116 in the inner surface 104. In some examples, the glaze 334 may adhere the radiant heating element 206 to the inner surface 304. In some examples where the inner surface 104 does not include a groove 116, not shown in FIGS. 3A-C, the glaze 334 may still be used to adhere the radiant heating element 206 to the inner surface 104 by at least partially encapsulating the radiant heating element 206. In some applications, including the groove 116 in the inner surface 104, may allow less glaze 334 to be used. In some examples, the glaze 334 may provide electrical insulation. In some examples, the glaze 334 may include ceramic fibers. In some examples, the glaze 334 may be an ambient temperature air-dry glaze.

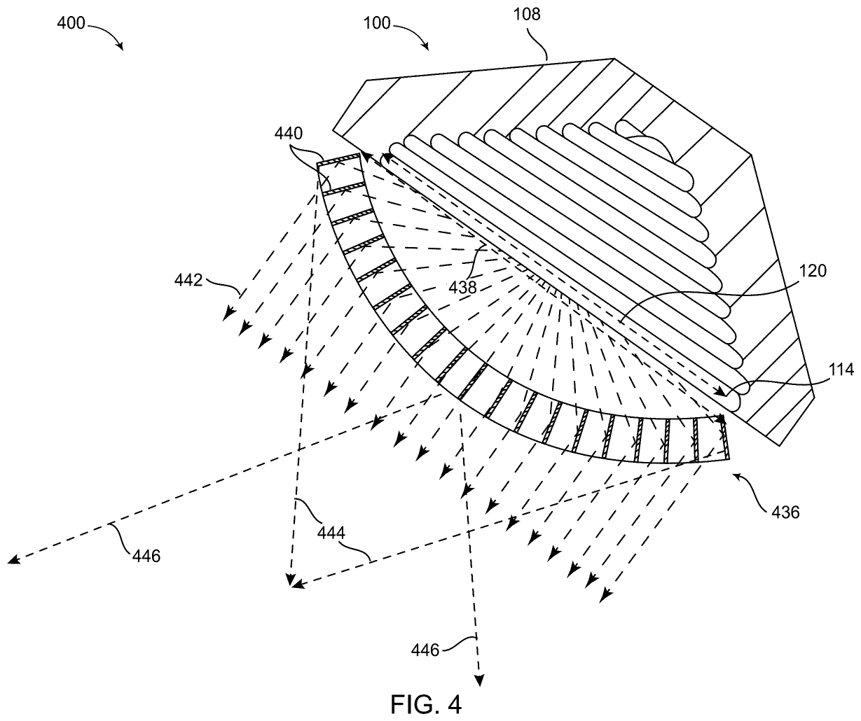

FIG. 4 shows a cross section of an electric radiant heater assembly 400 according to an illustrated embodiment of the present disclosure. In some examples, the electric radiant heater assembly 400 may include the electric radiant heater 100. The electric radiant heater assembly 400 may further include a lens 436 having a diameter 438. In some examples, the diameter 438 of the lens 436 may be equal or greater to the diameter 120 of the aperture 114 of the cavity 102. In some examples, the lens 436 may include one or more reflectors 440. The lens 436 may direct electric radiant heat provided by the radiant heating element 206 (not shown in FIG. 4) to a location outside the cavity 102.

In some examples, the electric radiant heat may be directed in parallel lines (e.g., beam) 442 away from the aperture 114. In other examples, the lens 436 may focus the electric radiant heat to a point outside the cavity 102 as indicated by dashed lines 444. In further examples, the lens 436 may disperse the electric radiant heat outside the cavity 102 as indicated by dashed lines 446. Whether the electric radiant heat is transmitted as a beam, focused, and/or dispersed may be based, at least in part, on a curvature of the lens 436, an arrangement of the reflectors 440, and/or a distance between the lens 436 and the aperture of the cavity 102. In some examples, a distance between the lens 436 and the aperture may be equal to a focal distance of the lens 436. In some examples, the reflectors 440 may be adjustable to focus or disperse the electric radiant heat.

Examples of lenses that may be used to implement the lens 436 may be found in U.S. Pat. Nos. 4,841,947 and 4,896,656, which are incorporated herein by reference for any purpose. However, other lenses may be used to implement lens 436 in other examples. In some examples, the lens 436 may further increase the watts per square inch provided by the electric radiant heater assembly 400 to a location outside the cavity 102 compared to the watts per square inch at the aperture 114. In some examples, the lens 436 may further inhibit free airflow across the radiant heating element 406, which may reduce convective gas flows. In some examples, the lens 436 may act as a secondary radiant heat source.

In some examples, the radiant cavity heaters according to the embodiments of the present disclosure may provide more heat at an aperture than a flat radiant heater, without increasing the diameter of the radiant heater. Alternatively or additionally, the larger surface area may allow portions of the radiant heating element to be spaced further apart. In some examples, the radiant cavity heaters disclosed herein may have higher heat output, higher efficiency, and/or higher reliability.

Example 1 may include an apparatus comprising: a cavity having a concave inner surface, wherein an area of the inner surface is greater than an aperture of the cavity; and a coil at least partially embedded within a portion of the inner surface in a helical pattern, wherein the coil is partially embedded within the portion of the inner surface to provide electric radiant heating.

Alternatively and/or additionally, Example 2 comprises Example 1, wherein 20% or less of a diameter of the coil is embedded within the portion of the inner surface.

Alternatively and/or additionally, Example 3 comprises one or more of Examples 1-2, wherein the coil comprises a 1500 watt electric coil element.

Alternatively and/or additionally, Example 4 comprises one or more of Example 1-3, wherein a pitch of the helical pattern is such that a first portion of the coil in a first rotation of the helical pattern is spaced apart from a second portion of the coil in a second rotation of the helical pattern.

Alternatively and/or additionally, Example 5 comprises one or more of Examples 1-4, wherein a space between the first portion of the coil and the second portion of the coil is based, at least in part, on a voltage to be applied to the coil.

Alternatively and/or additionally, Example 6 comprises one or more of Examples 1-5, wherein the cavity includes a base of the inner surface opposite the aperture of the cavity, wherein the second rotation of the helical pattern is located farther from the base and closer to the aperture than the first rotation of the helical pattern, and the second rotation of the helical pattern receives infrared heat emanating from the first portion of the coil in the first rotation of the helical pattern.

Alternatively and/or additionally, Example 7 comprises one or more of Examples 1-6, wherein the concave surface includes a groove configured to accept at least a portion of the coil.

Alternatively and/or additionally, Example 8 comprises one or more of Examples 1-7, wherein a depth of the groove accepts 20% or less of the coil.

Alternatively and/or additionally, Example 9 comprises one or more of Examples 1-8, wherein the groove includes an overhang configured to retain at least the portion of the coil within the groove.

Alternatively and/or additionally, Example 10 comprises one or more of Examples 1-9, wherein the cavity is formed in a thermally insulative material.

Alternatively and/or additionally, Example 11 comprises one or more of Examples 1-10, wherein the thermally insulative material includes aluminum oxide fibers.

Alternatively and/or additionally, Example 12 comprises one or more of Examples 1-11, further comprising a ceramic glaze layer on the inner surface and at least partially encapsulating the coil.

Alternatively and/or additionally, Example 13 comprises one or more of Examples 1-12, wherein the inner surface comprises an angle or a curvature such that a portion of the coil is in optical view of all other portions of the coil not embedded within the portion of the inner surface.

Example 14 may include an electric radiant heater assembly, comprising: a cavity having a concave inner surface, wherein an area of the inner surface is greater than an aperture of the cavity; a radiant heating element at least partially embedded within a portion of the inner surface, wherein the radiant heating element is partially embedded in a helical pattern on the inner surface to provide radiant electric heating; and a lens, wherein a diameter of the lens is equal to or greater than a diameter of the aperture, wherein the lens directs the electric radiant heat provided by the radiant heating element to a location outside the cavity.

Alternatively and/or additionally, Example 15 comprises Example 14, wherein a distance between the lens and the aperture is equal to a focal distance of the lens.

Alternatively and/or additionally, Example 16 comprises one or more of Examples 14-15, wherein the lens comprises a plurality of reflectors.

Alternatively and/or additionally, Example 17 comprises one or more of Examples 14-16, wherein at least some of the plurality of reflectors are adjustable to focus or disperse the electric radiant heat.

Alternatively and/or additionally, Example 18 comprises one or more of Examples 14-17, wherein the radiant heating element radiates heat responsive to an electric current passed through the radiant heating element.

Alternatively and/or additionally, Example 19 comprises one or more of Examples 14-18, wherein the radiant electric heat at the aperture of the cavity is at least 150 watts per square inch.

Alternatively and/or additionally, Example 20 comprises one or more of Examples 14-19, wherein the inner surface comprises a shape such that a portion of the radiant heating element is in optical view of all other portions of the radiant heating element not embedded within the portion of the inner surface.

Of course, it is to be appreciated that any one of the examples, embodiments or processes described herein may be combined with one or more other examples, embodiments and/or processes or be separated and/or performed amongst separate devices or device portions in accordance with the present apparatuses, devices and methods.

Finally, the above-discussion is intended to be merely illustrative of the present apparatuses and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a cavity having a concave inner surface, wherein an area of the inner surface is greater than an aperture of the cavity; and
a coil at least partially embedded within a portion of the inner surface in a helical pattern, wherein the coil is partially embedded within the portion of the inner surface to provide electric radiant heating.

2. The apparatus of claim 1, wherein 20% or less of a diameter of the coil is embedded within the portion of the inner surface.

3. The apparatus of claim 1, wherein the coil comprises a 1500 watt electric coil element.

4. The apparatus of claim 1, wherein a pitch of the helical pattern is such that a first portion of the coil in a first rotation of the helical pattern is spaced apart from a second portion of the coil in a second rotation of the helical pattern.

5. The apparatus of claim 4, wherein a space between the first portion of the coil and the second portion of the coil is based, at least in part, on a voltage to be applied to the coil.

6. The apparatus of claim 4, wherein the cavity includes a base of the inner surface opposite the aperture of the cavity, wherein the second rotation of the helical pattern is located farther from the base and closer to the aperture than the first rotation of the helical pattern, and the second rotation of the helical pattern receives infrared heat emanating from the first portion of the coil in the first rotation of the helical pattern.

7. The apparatus of claim 1, wherein the concave surface includes a groove configured to accept at least a portion of the coil.

8. The apparatus of claim 7, wherein a depth of the groove accepts 20% or less of the coil.

9. The apparatus of claim 7, wherein the groove includes an overhang configured to retain at least the portion of the coil within the groove.

10. The apparatus of claim 1, wherein the cavity is formed in a thermally insulative material.

11. The apparatus of claim 10, wherein the thermally insulative material includes aluminum oxide fibers.

12. The apparatus of claim 1, further comprising a ceramic glaze layer on the inner surface and at least partially encapsulating the coil.

13. The apparatus of claim 1, wherein the inner surface comprises an angle or a curvature such that a portion of the coil is in optical view of all other portions of the coil not embedded within the portion of the inner surface.

14. An electric radiant heater assembly, comprising:
a cavity having a concave inner surface, wherein an area of the inner surface is greater than an aperture of the cavity;
a radiant heating element at least partially embedded within a portion of the inner surface, wherein the radiant heating element is partially embedded in a helical pattern on the inner surface to provide radiant electric heating; and
a lens, wherein a diameter of the lens is equal to or greater than a diameter of the aperture, wherein the lens directs the electric radiant heat provided by the radiant heating element to a location outside the cavity.

15. The electric radiant heater assembly of claim 14, wherein a distance between the lens and the aperture is equal to a focal distance of the lens.

16. The electric radiant heater assembly of claim 14, wherein the lens comprises a plurality of reflectors.

17. The electric radiant heater assembly of claim 16, wherein at least some of the plurality of reflectors are adjustable to focus or disperse the electric radiant heat.

18. The electric radiant heater assembly of claim 14, wherein the radiant heating element radiates heat responsive to an electric current passed through the radiant heating element.

19. The electric radiant heater assembly of claim 14, wherein the radiant electric heat at the aperture of the cavity is at least 150 watts per square inch.

20. The electric radiant heater assembly of claim 14, wherein the inner surface comprises a shape such that a portion of the radiant heating element is in optical view of all other portions of the radiant heating element not embedded within the portion of the inner surface.
